(19) United States
(12) Patent Application Publication
(10) Pub. No.: US 2005/0140942 A1
(43) Pub. Date: Jun. 30, 2005

(54) Image device jamming apparatus and method

(76) Inventors: Steven Squires, Fort Wayne, IN (US); Robert E. Carter, Pittsboro, IN (US)

Correspondence Address: TAYLOR & AUST, P.C., 142 SOUTH MAIN STREET, P. O. BOX 560, AVILLA, IN, 46710, US

(21) Appl. No.: 10/843,126

(22) Filed: May 11, 2004

Related U.S. Application Data
(60) Provisional application No. 60/533,642, filed on Dec. 31, 2003.

(51) Int. Cl. G03B 21/00

(52) U.S. Cl. 353/122

(57) ABSTRACT

A method of compromising an image received by an image recording device including the steps of projecting light that is invisible to the human eye toward the image recording device and receiving a portion of the light along with the image by the image recording device. The portion of the light causing a degradation of the image.

### CROSS REFERENCE TO RELATED APPLICATIONS

This is a non-provisional application based upon U.S. provisional patent application Ser. No. 60/533,642, entitled “IMAGE DEVICE JAMMING APPARATUS”, filed Dec. 31, 2003.

### BACKGROUND OF THE INVENTION

1. Field of the Invention

The present invention relates to a device that degrades an image received by an image recording device, and, more particularly, to a light emitting jamming device.

2. Description of the Related Art

Cameras, particularly digital cameras have benefited from the advances in technology to the point where such cameras are small in size and have a substantial picture storage capability. In the movie picture industry, for example, new releases of movies are often not available for purchase by the general public. This creates a market that is satisfied by black marketers who utilize digital camera technology to record a newly released movie in a theater and then utilize the captured image to duplicate and sell unauthorized copies to the public. This results in a loss of revenue to movie companies by reducing the number of individuals who will buy tickets to see the movie and it reduces the demand for video tapes and DVD's that are released at a later time.

Additionally, owners of objects, such as paintings, often post signs that their art work is not to be photographed. However, it is difficult to prevent small digital cameras from being utilized to take undesired and unauthorized photographs of protected objects.

Unauthorized photographing of copyrighted materials constitutes a violation of rights retained by the owners of the objects and/or images. Law enforcement agencies have groups of officers that are dedicated to stop the copying and distribution of these illegal copies. Such an effort is directed toward the individuals that are duplicating the stolen images.

What is needed in the art is a method to make the pirated images less marketable to thereby dissuade the capturing of the images in an unauthorized manner.

### SUMMARY OF THE INVENTION

The present invention provides an image device jamming apparatus and method, which is utilized to render an image recorded by a digital camera to be degraded in quality in some fashion.

The invention comprises, in one form thereof, a method of compromising the functioning of an image recording device including the steps of projecting light upon an object, the light being invisible to the human eye and receiving an image of the object along with at least a portion of the light by an image recording device, the portion of the light altering the image recorded by the image recording device.

An advantage of the present invention is that the image, as viewed by the human eye, is not altered by the method.

Another advantage of the present invention is that it takes advantage of the digital camera's sensitivity to invisible light.

Yet another advantage is that the present invention can be incorporated with currently utilized technology in movie theaters.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematical view of one embodiment of the jamming apparatus of the present invention;

FIG. 2 is a schematical view of another embodiment of the jamming apparatus of the present invention;

FIG. 3 is a schematical view of yet another embodiment of the jamming apparatus of the present invention;

FIG. 4 is a schematical view of an application of the jamming apparatus of FIG. 3;

FIG. 5 is a view of an image of an object shown in FIGS. 1-4;

FIG. 6 illustrates an image received by an image recording device of the object in FIGS. 1-4 as modified by a jamming apparatus of the present invention;

FIG. 7 is a schematical view of another embodiment of the present invention illustrating a portion of a projection screen as shown in FIG. 4; and

FIG. 8 illustrates yet another embodiment of the present invention with light transmitting devices embedded into the screen of FIGS. 4 and 7.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

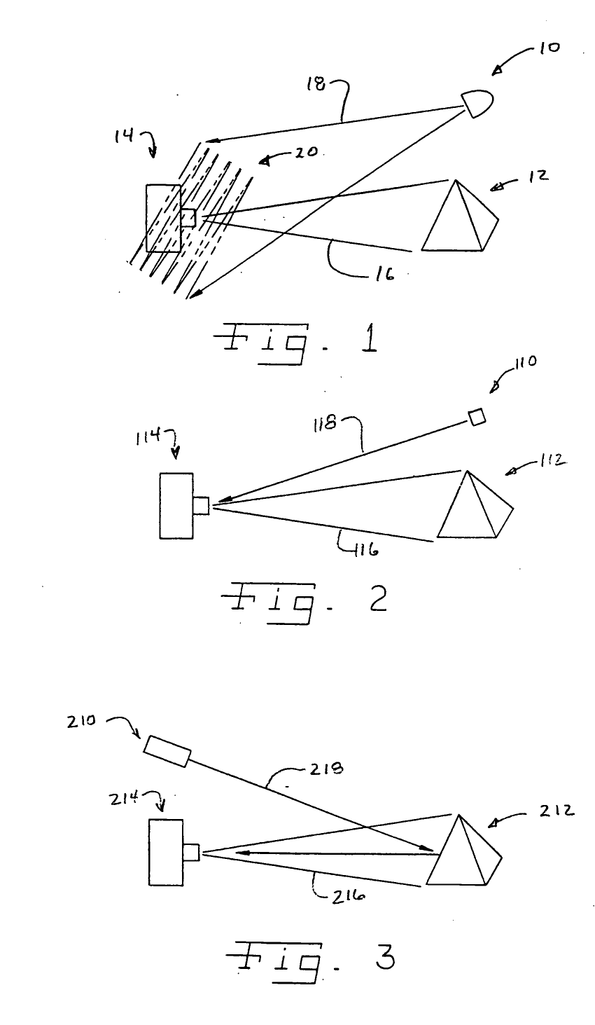

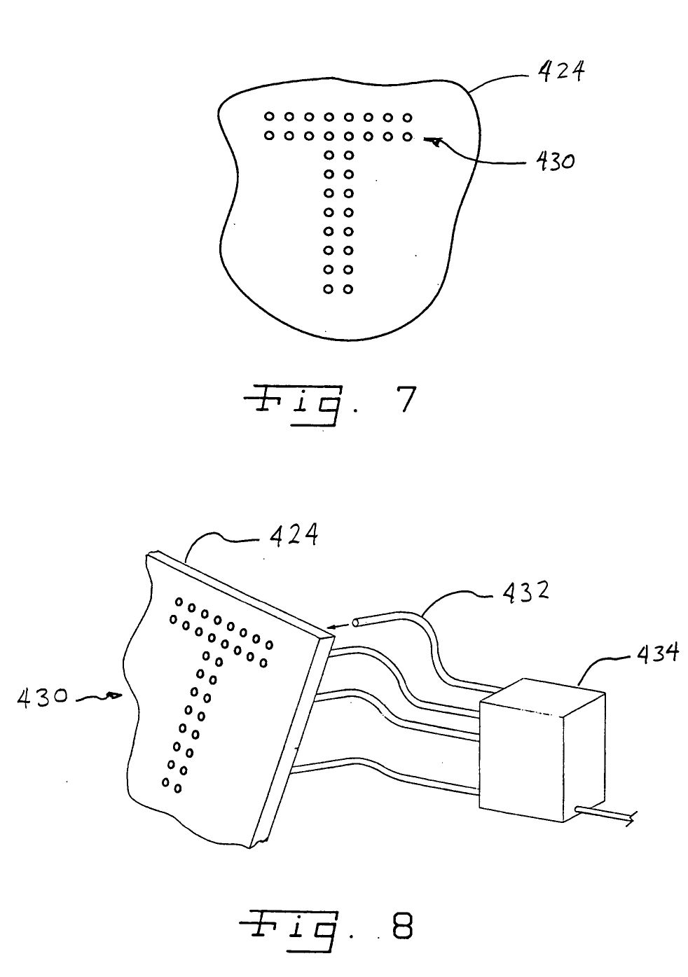

Referring now to the drawings, and more particularly to FIG. 1, there is shown an embodiment of an image jamming apparatus 10 of the present invention, which generally is situated and oriented relative to an object 12 and an imaging device 14. An operator of imaging device 14, also known as camera 14, and more particularly a digital camera 14, orients the lens thereof towards an object 12 in order to photograph object 12. The photographic terminology utilized herein is intended to include still photograph and video recording methods. The operator of camera 14 orients the lens thereof so that light 16 from object 12 enters through the optics of camera 14 to form an image therein. Jamming device 10 emits a light beam 18, which is invisible to the human eye. Light beam 18 is scanned in a pattern 20 in a direction in which it is considered likely that a photograph will be taken from. Light beam 18 may be an infrared light, which enters the optics of camera 14 and thereby distorts, degrades or conveys a message on top of the image of object 12 taken by camera 14. As way of illustration, FIG. 5 illustrates an image 26 of object 12 that is perceived by the human eye. FIG. 6 illustrates an image taken by camera 14 in which a message has been superimposed upon image 26 indicating that the image is protected by I.R. light. Alternative to the text message illustrated in FIG. 6, may distort the image recording devices capabilities causing a light blooming or other distortion of image 12, thereby degrading the recorded image and reducing its usefulness to the operator of camera 14.

The reference numbering scheme utilized herein retains the two least significant digits for similar items in the embodiments illustrated herein.

Now, additionally referring to FIG. 2, there is illustrated another embodiment of the present invention, which is substantially similar to that illustrated in FIG. 1. However, jamming apparatus 110 detects the presence of camera 114 either by way of human intervention or an automatic detection device and directs an invisible light beam 118 towards the optics of camera 114. This serves to degrade the image of object 112 that is received by way of light 116 by camera 114. The advantage of this embodiment of the present invention is that a less intense light 118 is utilized since the full energy is directed directly to the optics of camera 114.

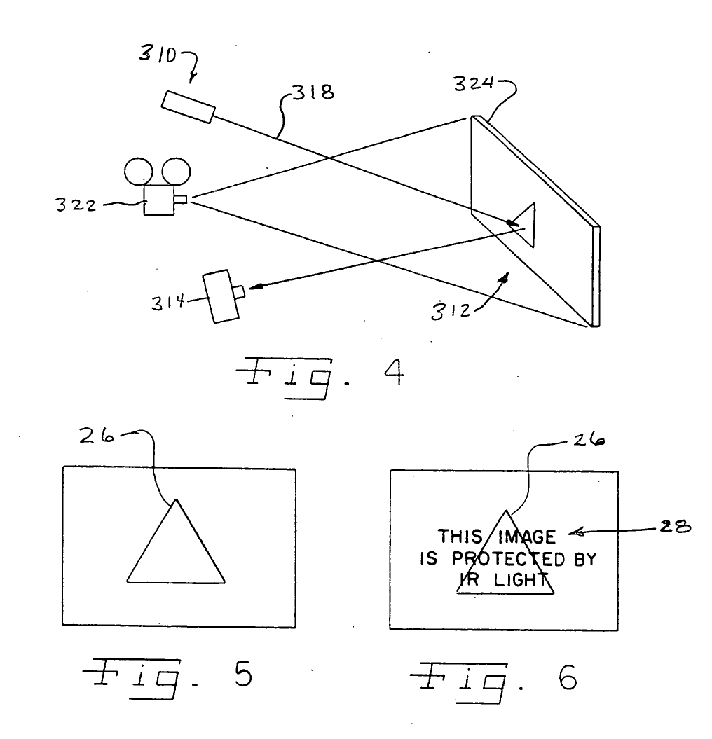

Now, additionally referring to FIG. 3, there is illustrated yet another embodiment of the present invention, where jamming apparatus 210 directs light 218, which is invisible to the human eye, toward object 212. Camera 214 is taking a photograph of object 212 by way of light 216, which is visible light that is reflected from object 212. Infrared light 218 is also reflected off of object 212 and is received by camera 214. The image visualized by the human eye is illustrated in FIG. 5 in the form of image 26 of object 212. Camera 214 receives light 216 and light 218 to generate an image 28 along with image 26. Image 28 is either a symbol, a text message and/or a distorting light, which simply distorts image 26. Text message 28 can convey information that the image is protected by law to dissuade the copying of the image received by camera 214. Light beam 218 may be scanned or projected upon object 212 in manners known in the art for visible light.

Now, additionally referring to FIG. 4, there is illustrated jamming apparatus 310, an image 312 and a camera 314. Image 312 is projected by projector 322 onto projection screen 324, as in a movie theater. Light beam 318 is directed towards projection screen 324 and is reflected therefrom, some of the light being received by camera 314. Light beam 318 may be scanned and/or projected in a fashion known in the art relative to visible light. The application of light beam 318 to screen 324 produces an image 28, such as that illustrated in FIG. 6, which is detectable by camera 314. Digital camera 314, by its nature, is sensitive to infrared light, which is not visible to the human eye. The sensitivity relates to the solid state detection device utilized by camera 314. As an audience views images on screen 324 they are unaware of the infrared message being painted upon screen 324, which is being detected by camera 314. The detected message by camera 314 indicates that the image being photographed is being copyrighted, or otherwise protected by law. Alternatively, light beam 318 may be a projection of a pattern causing great distortion of image 312 as it is received by camera 314.

Now, additionally referring to FIGS. 7 and 8 there is illustrated yet another embodiment of the present invention. FIG. 7 illustrates light emitting apparatuses 430 on a portion of screen 424, as in this example forming a letter ‘T’. Light emitting apparatuses 430 are attached to, or installed upon, screen 424. Light emitting apparatuses 430 may be light emitting diodes installed in screen 424 or optically infrared transmittable lenses or openings allowing infrared light to pass from screen 424 in a general direction towards camera 314. Additionally, light emitting apparatuses may be in the form of fiber optics as shown in FIG. 8, which are coupled to a light source 434. Fiber optic links 432 are installed into screen 424 thereby transmitting light from light emitting apparatuses 430. Alternatively, an infrared photo-fluorescent material can be placed on screen 324, which operates to receive visible light and then convert its energy and retransmit it at infrared light wavelengths. Light emitting apparatuses 430 are arranged to form a symbol or a message on screen 324, which is not visible to the human eye, yet conveys a message to camera 314 regarding the protection of the image on screen 324.

The present invention advantageously protects images from unauthorized recording to thereby protect valuable intellectual property rights of the owners of the objects and images, which are the subject of protection. While the embodiments illustrated herein are directed to objects and images, the protection can additionally be utilized in other areas such as in court rooms where photographs may be prohibited by court order and yet enforced by one of the embodiments of the present invention.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of compromising the functioning of an image recording device, comprising the steps of:
projecting light upon an object, said light being invisible to the human eye; and
receiving an image of said object along with at least a portion of said light by the image recording device, said at least a portion of said light altering said image.

2. The method of claim 1, wherein said light is substantially of an infrared wavelength.

3. The method of claim 1, wherein said light is projected on said object in the form of at least one of a text message and a graphic symbol.

4. The method of claim 3, wherein said light is projected by scanning said light upon said object.

5. The method of claim 4, wherein said object is a projection screen.

6. The method of claim 5, further comprising the step of projecting a visible light image upon said projection screen, said light conveying information relative to said visible light image.

7. A method of placing a message on an image received by a camera, the method comprising the steps of:
projecting the message onto an object, the message being invisible to the human eye; and
recording the image and the message using the camera.

8. The method of claim 7, wherein said message is projected on said object in the form of at least one of a text message and a graphic symbol.

9. The method of claim 8, wherein projecting step includes scanning light upon said object.

10. The method of claim 9, wherein said object is a projection screen.

11. The method of claim 10, further comprising the step of projecting a visible light image upon said projection screen, said message conveying information relative to said visible light image.

12. A method of compromising an image received by an image recording device, comprising the steps of:
projecting light that is invisible to the human eye toward the image recording device; and
receiving a portion of said light along with the image by the image recording device, said portion of said light causing a degradation of the image.

13. The method of claim 12, wherein the image recording device is sensitive to infrared light.

14. The method of claim 12, wherein said degradation is in the form of at least one of a text message, a graphic symbol and distortion of the image.

15. The method of claim 14, wherein said image is visible light projected onto a projection screen.

16. The method of claim 15, wherein said text message conveys information relative to said image.

17. The method of claim 16, wherein said information indicates that said image is protected by law.

18. The method of claim 17, wherein said projecting step includes transmitting said light that is invisible to the human eye by way of a plurality of light transmitting devices connected to said projection screen.

19. The method of claim 18, wherein said plurality of light transmitting devices include at least one of light emitting diodes, fiber-optics and infrared photo-fluorescent material.

20. The method of claim 12, wherein said light that is invisible to the human eye is substantially of an infrared wavelength.
